(19) United States
(12) Patent Application Publication
(10) Pub. No.: US 2009/0119490 A1
(43) Pub. Date: May 7, 2009

(54) PROCESSOR AND INSTRUCTION SCHEDULING METHOD

(76) Inventors: Taewook Oh, Seoul (KR); Hong-Seok Kim, Seongnam-si (KR); Scott Mahlke, Ann Arbor, MI (US); Hyun Chul Park, Ann Arbor, MI (US)

Correspondence Address: MCNEELY BODENDORF LLP, P.O. BOX 34175, WASHINGTON, DC, 20043, US

(21) Appl. No.: 12/052,356

(22) Filed: Mar. 20, 2008

(30) Foreign Application Priority Data
Nov. 7, 2007 (KR) 10-2007-0113435

(51) Int. Cl. G06F 9/312

(52) U.S. Cl. 712/214; 712/E09.033

(57) ABSTRACT

An instruction scheduling method and a processor using an instruction scheduling method are provided. The instruction scheduling method includes selecting a first instruction that has a highest priority from a plurality of instructions, and allocating the selected first instruction and a first time slot to one of the functional units, allocating a second instruction and a second time slot to one of the functional units, wherein the second instruction is dependent on the first instruction.

### CROSS-REFERENCE TO RELATED APPLICATION

This application claims the benefit under 35 U.S.C. §119(a) of a Korean Patent Application No. 10-2007-0113435, filed on Nov. 7, 2007, in the Korean Intellectual Property Office, the entire disclosure of which is incorporated herein by reference.

### TECHNICAL FIELD

The following description relates to a reconfigurable processor, and more particularly, to methods and apparatuses for implementing an instruction scheduling.

### BACKGROUND

Generally, operation processing apparatuses have been embodied using a hardware or software. In an exemplary hardware scheme, when a network controller is installed on a computer chip, the network controller performs only a network interfacing function that is defined during its fabrication in a factory. Therefore, after the fabrication of the network controller, it is typically not possible to change the function of the network controller. In an exemplary software scheme, a user desired function may be satisfied by constructing a program to perform the desired function and executing the program in a general purpose processor. In a software scheme, a new function may be performed by replacing the software even after the hardware was fabricated in the factory. However, while it may be possible to perform various types of functions using the given hardware, execution speed may be decreased in comparison to that of a hardware scheme.

To overcome the disadvantages of hardware and software schemes, a reconfigurable processor architecture has been proposed. A reconfigurable processor architecture may be customized to solve a given problem even after fabricating a device. Also, a reconfigurable processor architecture may use a spatially customized calculation to perform calculations.

A reconfigurable processor architecture may be embodied by using a coarse-grained array (CGA) and a processor core that may process a plurality of instructions in parallel.

Accordingly, there is a need for an instruction scheduling method that reduces a schedule time of instructions that are executed in a reconfigurable processor architecture, embodied by, for example, using a CGA, and a processor structure using the method.

### SUMMARY

In one general aspect, there is provided an algorithm that schedules instructions that are executed in a reconfigurable processor.

In another general aspect, there is provided an instruction scheduling method that reduces a schedule time of instructions that are executed in a reconfigurable processor.

A reconfigurable processor architecture may be embodied by using a coarse-grained array (CGA) and a processor core that may process a plurality of instructions in parallel.

In still another general aspect, a processor for executing a plurality of instructions includes a plurality of functional units to execute the plurality of instructions, and a scheduling unit which allocates a first instruction and a first time slot to one of the functional units and allocates a second instruction and a second time slot to one of the functional units, wherein the first instruction has a highest priority among the plurality of instructions and the second instruction is dependent on the first instruction. The plurality of functional units may respectively execute any one of the instructions in a predetermined time slot. The scheduling unit may initially allocate the first instruction and the first time slot to one of the functional units and subsequently allocate the second instruction and the second time slot.

In yet another general aspect, an instruction scheduling method in a processor having a plurality of functional units, includes selecting a first instruction that has a highest priority from a plurality of functional instructions, allocating the selected first instruction and a first time slot to one of the functional units, allocating a second instruction and a second time slot to one of the functional units, wherein the second instruction is dependent on the first instruction, determining whether the second instruction and the second time slot is validly allocated to one of the functional units, and reallocating the selected first instruction and the first time slot to one of the functional units where the allocation of the second instruction and the second time slot is determined to be invalid.

Other features will become apparent to those skilled in the art from the following detailed description, which, taken in conjunction with the attached drawings, discloses exemplary embodiments of the invention

### BRIEF DESCRIPTION OF THE DRAWINGS

FIG. 1 is a block diagram illustrating an exemplary processor.

FIG. 2 is a block diagram illustrating another exemplary processor.

FIG. 3 is a flowchart illustrating an exemplary instruction scheduling method.

FIG. 4 is a flowchart illustrating a part of an exemplary instruction scheduling method.

FIG. 5 is a flowchart illustrating a part of an exemplary instruction scheduling method.

FIG. 6 is a flowchart illustrating a part of an exemplary instruction scheduling method.

FIG. 7 is a flowchart illustrating a part of an exemplary instruction scheduling method.

Throughout the drawings and the detailed description, the same drawing reference numerals will be understood to refer to the same elements, features, and structures.

### DETAILED DESCRIPTION

The following detailed description is provided to assist the reader in gaining a comprehensive understanding of the methods and systems described herein. According, various changes, modifications, and equivalents of the systems and methods described herein will be suggested to those of ordinary skill in the art. Also, description of well-known functions and constructions are omitted to increase clarity and conciseness.

A reconfigurable array may denote a kind of an accelerator that is used to improve the execution speed of a program and also denote a plurality of functional units that may process various types of operations. A platform using an application-specific integrated circuit (ASIC) may perform operations more quickly than a general purpose processor. However, the platform using the ASIC may not process various types of applications. Conversely, a platform using a reconfigurable array may process many operations in parallel. Therefore, the platform using the reconfigurable array may improve performance and also provide flexibility in processing of the operations. Accordingly, a platform using a reconfigurable array may be used for a next generation digital signal process (DSP).

In order to effectively use a structure with a plurality of functional units, such as a reconfigurable array, instruction level parallelism (ILP) of an application may be desired. An improved scheme of the ILP may use a scheme that appropriately schedules independent repeated instructions in a loop to accelerate the loop in the application. The scheduling scheme may be referred to as a software pipelining scheme. An example of the software pipelining scheme includes a modulo scheduling.

In a reconfigurable array, the connectivity between a plurality of functional units may be sparse. Therefore, an optimized scheduling scheme is desirable in the reconfigurable array. A general scheduler performs scheduling in a state where a connection between a functional unit that generates a result value and another functional unit that uses the generated result value, is fixed. Therefore, where the scheduler performs only a function of placing an instruction in the functional unit, it may be sufficient. However, in the reconfigurable array, functional units are connected to each other in a form of a mesh-like network and thus register files are distributed among the functional units. Therefore, a scheduler of the reconfigurable array may need to perform a function of transferring a result value of each functional unit to another functional unit of the reconfigurable array using the generated result value. Specifically, the scheduler of the reconfigurable array may need to perform a function of generating a routing path of the generated result value.

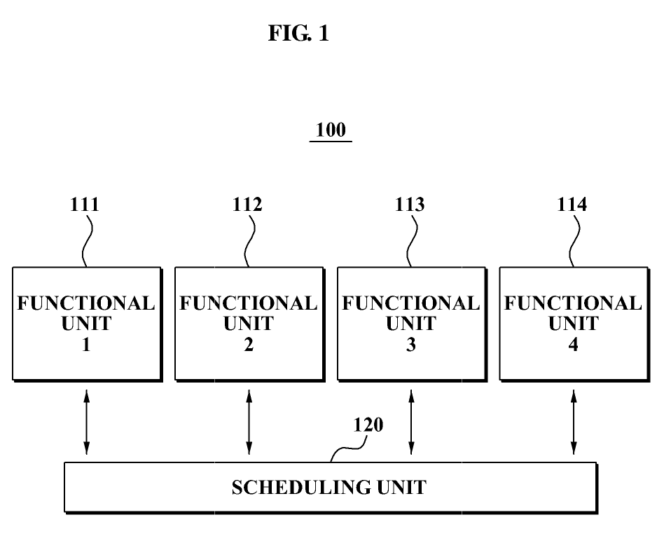

FIG. 1 illustrates an exemplary processor 100.

As illustrated in FIG. 1, the processor 100 includes four functional units (1 through 4) 111, 112, 113, and 114, and a scheduling unit 120.

Each of the functional units (1 through 4) 111, 112, 113, and 114 may execute an instruction in a predetermined time slot.

The scheduling unit 120 selects a first instruction from a plurality of instructions. The first instruction has a highest priority among the plurality of instructions. The scheduling unit 120 allocates the first instruction and a first time slot to one of the functional units (1 through 4) 111, 112, 113, and 114.

In one embodiment, the scheduling unit 120 may allocate a loop start instruction or a loop end instruction to one of the functional units (1 through 4) 111, 112, 113, and 114, prior to the allocating of the first instruction.

In another embodiment, the scheduling unit 120 may allocate an instruction of receiving data from a register file or an instruction of transmitting data to the register file to one of the functional units (1 through 4) 111, 112, 113, and 114 prior to the allocating of the first instruction.

In still another embodiment, the scheduling unit 120 may allocate instructions that have cyclic dependency to one of the functional units (1 through 4) 111, 112, 113, and 114 prior to the allocating of the first instruction.

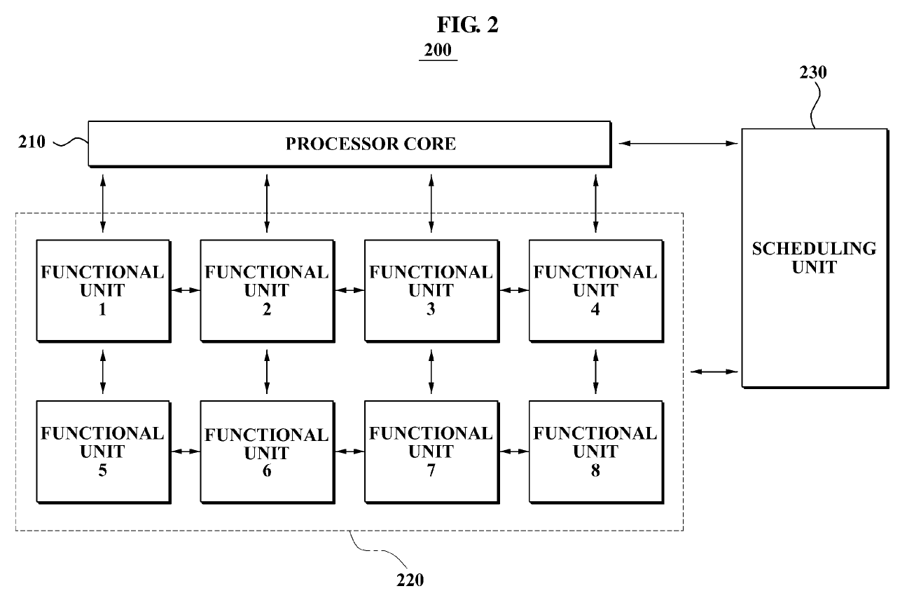

FIG. 2 illustrates another exemplary processor 200.

As illustrated in FIG. 2, the processor 200 includes a processor core 210, a coarse-grained array (CGA) 220, and a scheduling unit 230.

The CGA 220 includes eight functional units (1 through 8).

The scheduling unit 230 allocates instructions to the processor core 210 or the CGA 220. The scheduling unit 230 may allocate the instructions to the functional units (1 through 8) that are included in the CGA 220, respectively.

The scheduling unit 230 may allocate an instruction to one of the functional units (1 through 8) of the CGA 220, based on a modulo constraint. Also, the scheduling unit 230 may route a path of result values that are transferred between the instructions based on the connectivity between the functional units (1 through 8).

The scheduling unit 230 indicates as one node each instruction to be allocated to each functional unit (1 through 8) of the CGA 220. The scheduling unit 230 indicates data dependency between the instructions as an edge between nodes. Through this, the scheduling unit 230 generates a data flow graph.

The scheduling unit 230 indicates each functional unit (1 through 8) as one node and connectivity between the functional units (1 through 8) as an edge between the nodes and thereby generates an architecture graph.

Accordingly, the scheduling unit 230 may perform scheduling with respect to the instructions by mapping the data flow graph on the generated architecture graph.

The scheduling unit 230 may perform placement and routing with respect to functional units (1 through 8) of the CGA 220 for each node in the data flow graph. The scheduling unit 230 determines a priority of each node in the data flow graph and may sequentially schedule nodes in the data flow graph based on the determined priority.

The scheduling unit 230 computes the height of each node based on the data flow graph and may schedule the instructions in an order of the height.

As more nodes are ahead of a particular node, the height of the particular node may be defined as lower.

Among the nodes that are included in the data flow graph, there may be nodes for the scheduling unit 230 to place in advance and route regardless of the height. For example, the scheduling unit 230 may perform scheduling in advance with respect to a control node of determining a start and end of a loop, a live node of accessing a central register file, and nodes constituting a cycle in the data flow graph.

The control node may denote a loop start node and a loop end node. The control node may control a node of generating a staging predicate and thereby enable a prologue and epilogue of the scheduled loop to be appropriately processed.

Generally, the loop start node has the highest height in the data flow graph and starts processing, and thus, may be foremost scheduled.

The loop end node may have a structural constraint where the loop end node must receive an input value via a particular read port. Where another scheduled node occupies the read port prior to the loop end node, the instruction processing performance may be deteriorated. Accordingly, the scheduling unit 230 schedules the loop end node in advance.

The live node may receive a result value from a central register file, or transfer the result value to the central register file.

For example, in a converting procedure between a very long instruction word (VLIW) mode and a CGA mode of the processor core 210 that supports the VLIW mode, the live node accesses the central register file that transfers the result value between the processor core 210 and the CGA 220.

Where the live node must maintain a valid value during all schedule time, it is be scheduled in advance.

In the case of a general node, the general node may maintain a result value that is generated by a functional unit as a valid value until a result value that is generated by another functional unit is used. Therefore, routing resources that connect two functional units in the architecture graph may have only to maintain the result values within the live range of the result values.

However, in the case of the live node, it may be desirable for the routing resources to transfer valid result values to the functional units during all scheduled times. Therefore, the live nodes may exclusively occupy one slot of the central register file during all scheduled times.

A process in which the scheduling unit 230 routes a back-edge of a cycle is performed within more limited conditions than in a process of routing a general edge. Therefore, the scheduling unit 230 schedules nodes that constitute a cycle in the data flow graph in advance.

In a process of routing a general edge, where it is impossible to retrieve a valid routing path with respect to a scheduled time between a destination node and a given source node, another routing path may be retrieved while adjusting the scheduled time of the destination node within the allowed range. Even though the scheduled time of the destination node is changed, it does not affect scheduling of another node or edge. However, when routing the back-edge of the cycle, the destination node of the edge becomes the source node of the cycle. Therefore, where the scheduled time of the destination node is changed, scheduling of all edges and nodes that constitute the cycle may be corrected. Therefore, routing of the back-edge is performed under the condition that the scheduled time of the destination node may not be adjusted. Accordingly, the scheduling unit 230 may schedule the nodes that constitute the cycle in advance.

The scheduling unit 230 initially performs scheduling with respect to the control node, the live node, and the cycle node and then sequentially performs placement with respect to remaining nodes in a priority order based on the height. The scheduling unit 230 selects a first node with the highest priority and places the selected first node, and then routes edges connected to the first node.

The scheduling unit 230 searches for a functional unit that cannot process an instruction corresponding to the first node. The scheduling unit 230 searches for the time range in which a node can be scheduled based on the height of the first node and a latency of the instruction corresponding to the first node. The time range is a set of discrete time slots.

The scheduling unit 230 may select an order pair of <functional unit, time slot>and place the selected first node in the order pair.

The scheduling unit 230 initially places the first node in the order pair and then routes the edges that are connected to the first node. Through this, the scheduling unit may determine whether the placement of the first node is valid. Where routing fails in any one of the edges that are connected to the first node, the scheduling unit 230 places the first node in another order pair of <functional unit, time slot> and re-routes the edges that are connected to the first node. Where the valid placement is not retrieved with respect to all probable order pairs of <functional unit, time slot>, scheduling of the scheduling unit 230 may be regarded as a failure.

Where routing of the edge succeeds, the scheduling unit 230 may transfer a result value using routing resources that exist in the architecture graph from an output port of a source node of the edge to an input port of a destination node of the edge.

The scheduling unit 230 searches for a routing resource adjacent to the output port of the source node of the edge, based on the architecture graph. The architecture graph includes a time latency that occurs in transferring the result value between the output port and the adjacent routing resource. Where an unoccupied routing resource exists at time t, the scheduling unit 230 regards that there exists a path incapable of transferring the result value from the output port to the unoccupied routing resource and completes scheduling of the edge. In this instance, t=schedule time of output port+time latency.

The scheduling unit 230 may not consider scheduling with respect to a path that has a relatively greater time latency than the schedule time difference between the source node and the destination node.

The scheduling unit 230 may make a plurality of paths not be in the same time slot with respect to one routing resource.

The scheduling unit 230 may search for one routing path from the source node to the destination node, and may terminate routing of the edge without making an attempt to search for another path. According to the scheduling policy of the scheduling unit 230, the optimization time of scheduling may not be used to thereby reduce the schedule time.

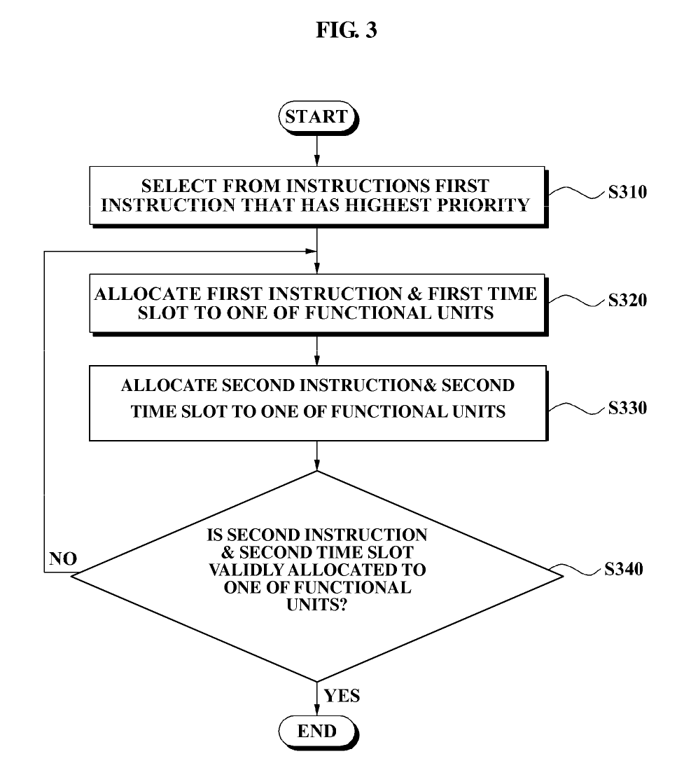

FIG. 3 illustrates an exemplary instruction scheduling method.

Referring to FIG. 3, in operation S310, the instruction scheduling method selects a first instruction that has the highest priority among a plurality of instructions.

In operation S320, the instruction scheduling method allocates the selected first instruction and a first time slot to one of functional units.

In operation S330, the instruction scheduling method allocates a second instruction and a second time slot to one of the functional units. The second instruction is dependent on the first instruction. Also, the instruction scheduling method may select a functional unit to be allocated based on the connectivity between the functional units.

In operation S340, the instruction scheduling method determines whether the second instruction and the second time slot is validly allocated to one of the functional units.

Where the allocation of the second instruction and the second time slot is determined to be invalidly allocated, the instruction scheduling method performs operation S320 again.

In one embodiment, the instruction scheduling method may be executed in a processor that includes a plurality of functional units.

In another embodiment, the instruction scheduling method may be executed in a processor that includes a CGA and a processor core. The CGA includes a plurality of functional units. The instruction scheduling method may allocate instructions to the functional units, respectively and thereby schedule each instruction.

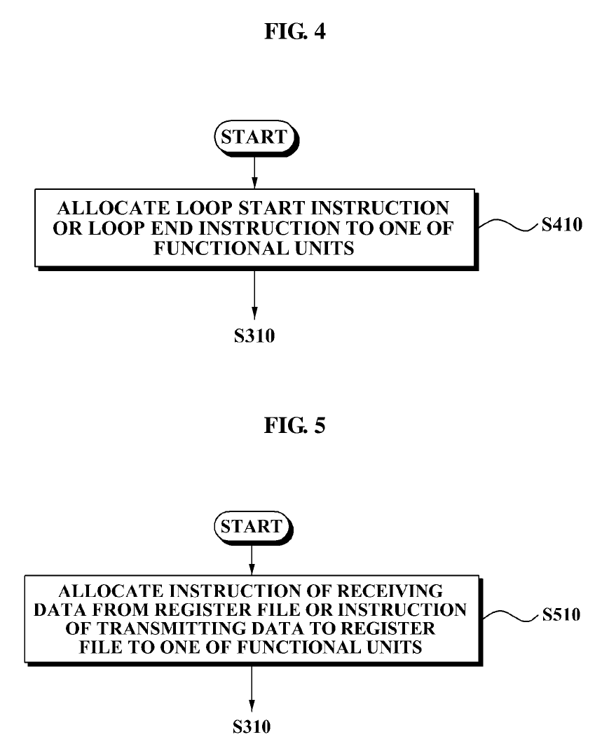

FIG. 4 illustrates a part of an instruction scheduling method.

Referring to FIG. 4, before performing operation S310, in operation S410, the instruction scheduling method allocates a loop start instruction or a loop end instruction to one of the functional units.

FIG. 5 illustrates a part of an instruction scheduling method.

Referring to FIG. 5, before performing operation S310, in operation S510, the instruction scheduling method allocates an instruction of receiving data from a register file or an instruction of transmitting the data to the register file to one of the functional units.

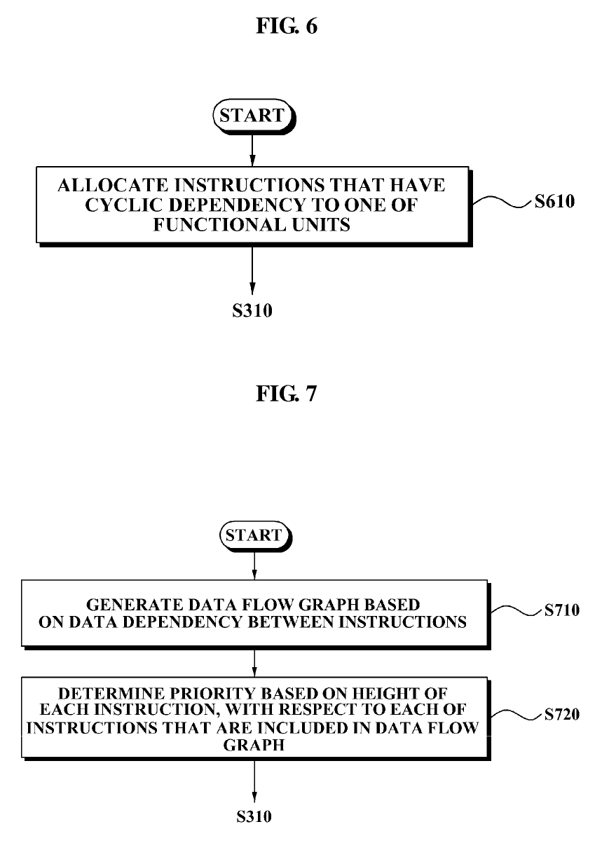

FIG. 6 illustrates a part of an instruction scheduling method.

Referring to FIG. 6, before performing operation S310, in operation S610, the instruction scheduling method allocates instructions that have cyclic dependency to one of the functional units.

FIG. 7 illustrates a part of an instruction scheduling method.

Referring to FIG. 7, before performing operation S310, in operation S710, the instruction scheduling method generates a data flow graph based on data dependency between the plurality of instructions.

In operation S720, the instruction scheduling method determines a priority based on the height of each instruction, with respect to each of the instructions that are included in the data flow graph.

The above-described methods including exemplary instruction scheduling methods of a reconfigurable processor may be recorded, stored, or fixed in one or more computer-readable media that includes program instructions to be implemented by a computer to case a processor to execute or perform the program instructions. The media may also include, independent or in combination with the program instructions, data files, data structures, and the like. Examples of computer-readable media may include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A processor for executing a plurality of instructions, comprising:
a plurality of functional units to execute the plurality of instructions; and
a scheduling unit which allocates a first instruction and a first time slot to one of the functional units and allocates a second instruction and a second time slot to one of the functional units, wherein the first instruction has a highest priority among the plurality of instructions and the second instruction is dependent on the first instruction.

2. The processor of claim 1, further comprising:
a processor core; and
a coarse-grained array which includes the plurality of functional units,
wherein the instructions are allocated to either the processor core or the coarse-grained array.

3. The processor of claim 1, wherein a loop start instruction or a loop end instruction, among the plurality of instructions, is allocated to one of the functional units prior to the first instruction.

4. The processor of claim 1, wherein an instruction of receiving data from a register file or an instruction of transmitting the data to the register file, among the plurality of instructions, is allocated to one of the functional units prior to the first instruction.

5. The processor of claim 1, wherein instructions that have cyclic dependency, among the plurality of instructions, are allocated to one of the functional units prior to the first instruction.

6. The processor of claim 1, wherein the scheduling unit initially allocates the first instruction and the first time slot to one of the functional units and sequentially allocates the second instruction and the second time slot to one of the functional units.

7. An instruction scheduling method in a processor having a plurality of functional units, the method comprising:
selecting a first instruction that has a highest priority from a plurality of instructions;
allocating the selected first instruction and a first time slot to one of the functional units;
allocating a second instruction and a second time slot to one of the functional units, wherein the second instruction is dependent on the first instruction;
determining whether the second instruction and the second time slot is validly allocated to one of the functional units; and
reallocating the selected first instruction and the first time slot to one of the functional units where the allocation of the second instruction and the second time slot is determined to be invalid.

8. The method of claim 7, wherein the processor comprises a processor core and a coarse-grained array which includes the plurality of functional units, and
the allocating of the instructions comprises allocating the instructions to either the processor core or the coarse-grained array.

9. The method of claim 7, further comprising:
allocating a loop start instruction or a loop end instruction, among the plurality of instructions, to one of the functional units prior to the allocating of the first instruction.

10. The method of claim 7, further comprising:
allocating an instruction of receiving data from a register file or an instruction of transmitting the data to the register file, among the plurality of instructions, to one of the functional units prior to the allocating of the first instruction.

11. The method of claim 7, further comprising:
allocating instructions that have cyclic dependency, among the plurality of instructions, to one of the functional units prior to the allocating of the first instruction.

12. The method of claim 7, further comprising:
generating a data flow graph based on data dependency between the plurality of instructions; and
determining a priority based on a height of each instruction, with respect to each of the instructions that are included in the data flow graph.

13. The method of claim 7, wherein the allocating of the second instruction and the second time slot comprises selecting a functional unit to be allocated based on a connectivity between the plurality of functional units, and allocating the second instruction and the second time slot to the selected functional unit.

14. A computer-readable recording medium storing a program for implementing the method of claim 7.
